(19) United States
(12) Patent Application Publication
(10) Pub. No.: US 2011/0094459 A1
(43) Pub. Date: Apr. 28, 2011

(54) REGULATING A HYDROCARBON COMBUSTION PROCESS USING A SET OF DATA INDICATIVE OF HYDROCARBON FUEL CONSUMED CORRESPONDING TO A MONITORED ENGINE OPERATING CHARACTERISTIC

(75) Inventors: John Dee, Cheltenham (AU); Steve Fulton, Mornington (AU); Dan Kujawski, Bloomington, MN (US); Jason D. Tuzinkewich, Minneapolis, MN (US)

(73) Assignee: GEO Firewall Sarl, Luxembourg (LU)

(21) Appl. No.: 12/877,047

(22) Filed: Sep. 7, 2010

Related U.S. Application Data
(60) Provisional application No. 61/241,783, filed on Sep. 11, 2009.

(51) Int. Cl. F02B 43/12

(52) U.S. Cl. 123/3

(57) ABSTRACT

The Combustion Management System models each hydrocarbon combustion application and supplies a product gas, comprising a dynamic mixture of nascent hydrogen (H) and oxygen (O), to the internal combustion engine to propagate the formation of hydroxide radicals (OH) and thereby to improve the level of completion of the hydrocarbon combustion reaction. The Combustion Management System provides product gas volumetric requirement information; and takes into account the engine style, primary torque requests, and hydrocarbon fuel consumption information to develop an operating system specific application that produces consistent measurable results.

### CROSS-REFERENCE TO RELATED APPLICATIONS

This patent application claims priority to U.S. Provisional Patent Application Ser. No. 61/241,783 filed on Sep. 11, 2009. This application is also related to applications filed on the same date titled “System For Increasing The Level Of Completion Of Diesel Engine Hydrocarbon Combustion”; “System To Dynamically Vary The Volume Of Product Gas Introduced Into A Hydrocarbon Combustion Process”; “Product Gas Generator For Producing A Substantially Stoichiometric Mix Of Hydrogen And Oxygen”; “System For Producing A Substantially Stoichiometric Mix Of Hydrogen And Oxygen Using A Plurality Of Electrolytic Cells”; and “System For Regulating A Hydrocarbon Combustion Process Using A Substantially Stoichiometric Mix Of Hydrogen And Oxygen.” The foregoing applications are hereby incorporated by reference to the same extent as though fully disclosed herein.

### FIELD OF THE INVENTION

This system controls the operation of a hydrocarbon consuming process to improve the level of completion of the hydrocarbon combustion reaction by injecting a dynamically generated mixture of nascent hydrogen and oxygen into the combustion air to propagate the formation of hydroxide radicals, thereby promoting a higher degree of oxidative completion, and extracting more energy from the fuel and reduce the level of unburned hydrocarbons in the combustion exhaust.

### BACKGROUND OF THE INVENTION

It is a problem to increase the fuel efficiency of internal combustion engines. In particular, enhancing the efficiency and fuel versatility of internal combustion engines by introducing hydrogen into the system is a pursuit that has vexed engineers since the beginning of the 20^{th} Century. Interest in this pursuit has been inconsistent over the years, taking a back seat due to the difficulties in achieving consistency in successes, yet gaining support, but not success, during times of fuel scarcity and social environmental focus.

The methods of introducing hydrogen into the internal combustion engine have varied widely from hydrogenating bituminous fuels to administering gaseous hydrogen into the internal combustion engine's air supply. Theoretical computations have suggested the potential for gains in combustion efficiency on many levels, but the practical application has been dubious, yielding just the slightest glimpse of these theoretically possible combustion efficiency gains. The following description discusses several of these practical applications with a focus on the theory and variables responsible for inconsistencies or negative results.

### Hydrogen in History

Hydrogen was first suggested as a fuel for machinery in 1820 by W. Cecil's treatise, “On the application of hydrogen gas to produce a moving power in machinery.” Several incarnations of hydrogen-powered machines followed, most of which were very efficient, yet failed to achieve market success as a result of fuel cost and scarcity. In the end, fossil fuels (petroleum) won out as the primary mechanical fuel source, and hydrogen was all but forgotten in this arena.

The military mobilization efforts leading up to World War I saw a German force confronting petroleum fuel scarcity issues. Engineers decided that their best option was to utilize hydrogen to create a hybridized fuel using the bituminous fuels of which they had plenty, and Hydrogen Enhanced Combustion (HEC) was born. By the end of the war, the dubious results produced by HEC attempts and a sharp decline in the need to pursue this approach led to a relative cessation of research in this field.

The petroleum supply crisis of the 1970's marked the second wave of interest in HEC research. This wave was largely a garage movement and sparked a shift in the production of hydrogen and its application within the internal combustion engine. Electrolysis as a means for onboard gaseous hydrogen generation was the process favored by the HEC hobbyist, and several advances were made in the realm of electrolytic decomposition of water. Meanwhile, fossil fuel reformation was the common mechanism employed by the scientific community as a more efficient means to a higher yield for gaseous hydrogen generation. This technology also saw marked advances in efficiency. Learning from the issues with the earlier German studies, gaseous hydrogen was administered as a separate entity, either directly injected into the cylinders of the internal combustion engine or mixed with the engine's air supply.

As petroleum supplies again became more accessible, the interest in HEC experienced a decline until recent environmental awareness met with forecasts of fossil fuel depletion to promote a surge in the hydrogen economy movement. Many companies were formed to promote products similar to those touted for their successes in the 1970's, making extraordinary claims with respect to fuel savings and emissions reductions. Despite all of the claims, no government agency has approved such a technology to date. Meanwhile, internal combustion engine manufacturers and research institutions alike have been working with renewed effort and expanded budgets to achieve marketable successes with hydrogen. The majority of this community has focused its resources on fuel cell technology, deeming the difficulties in applying HEC to the internal combustion engine to be prohibitive. A handful of research institutions have conducted studies, with limited success, ultimately agreeing that the difficulties outweigh the potential gains.

### Hydrogen Enhanced Combustion Model

The original model for Hydrogen Enhanced Combustion was predicated upon preparing bituminous fuels to be usable in internal combustion engines. To this end, the fuel was actually hydrogenated at a processing facility, and then shipped and stored in this hydrogenated form. The major complication in this process was the inherent stability of the resultant fuel. The hydrogen became so stable in this format that many of the theoretical attributes which made hydrogen originally enticing were not realized in the cylinders of the internal combustion engine. This stability issue manifested itself in the form of sluggish response and chronic backfiring of the internal combustion engine.

### Hydrogen Replacement Model

Today, the generally accepted model for Hydrogen Enhanced Combustion studies is the energetic replacement of diesel fuel with a hydrogen component. This model is hereby referred to as the “Hydrogen Replacement Model” (HRM). In the HRM, the quantity of hydrogen added to the diesel fuel is defined in energetic proportion to the diesel fuel consumed. The accepted premise of this model is that the energy derived from the combustion of diesel fuel is fixed within any particular system. The aim of hydrogen addition in the HRM is to decrease diesel fuel consumption by replacing a portion of the diesel fuel with a volume of combustible hydrogen that carries the same energetic value as the diesel fuel. Emissions in this model are expected to be reduced relative to the quantity of carbon-based diesel fuel omitted. In practice, however, side reactions and quenching also play a role in determining the emissions reductions. In laboratory testing, gaseous hydrogen has been administered to the diesel engine almost exclusively from compressed gas storage containers. In market applicability notes, fossil fuel reforming is cited as the most viable means for generating the requisite hydrogen supply, and the electrolytic production of hydrogen is determined to be too inefficient. With respect to a diesel engine, the following points best characterize the HRM:
The hydrogen combustion is characterized as being initiated via the compression ignition of the diesel fuel within the cylinders of the engine;
Energetics are valued and described in terms of separate hydrogen combustion and diesel combustion mechanisms;
Incomplete burning of both hydrogen fuel and diesel (hydrocarbon) fuel is observed and measured as a result of stoichiometric oxygen deficiencies relative to active sites; and
Large volumes of hydrogen addition are required to effect energetic substitution requirements.

In contrast to these limitations of the diesel engine application, HRM technologies have achieved a reasonable level of success in Otto Cycle applications where integration expands the lean operating limits of the system. In these applications, ignition is initiated by the spark plug, and the combustion of hydrogen becomes the primary reaction. In a Diesel Cycle system, this process is more dubious since the compression ignition of the diesel fuel is the reaction initiator. The volumes of hydrogen required to achieve energetic substitution create competitive hurdles, such as quenching, that inhibit a successful integration.

### Other Factors Worthy of Note

The standard diesel engine has specifically engineered air flow volumes which are designed to optimize stoichiometric concentrations of oxygen specific to the combustion of diesel fuel. If this combustion were to propagate to completion, the exhaust from the diesel engine would be comprised solely of carbon dioxide, water, and excess atmosphere. The presence of carbon monoxide, hydrocarbons, and soot are a consequence of other factors which inhibit the complete combustion of the diesel fuel.

Polymerization, a form of quenching, occurs when active sites in adjacent carbon molecules of the diesel fuel react with one another to form a longer carbon chain. This is the mechanism responsible for the generation of soot and many hydrocarbon products in a diesel engine. Polymerization occurs when no oxygen is proximate to the active sites on the diesel fuel carbon molecules to continue the oxidation before polymerization can occur.

Another major form of quenching is oxygen depletion. Every oxygen atom that comes out of the combustion chamber attached to anything other than a carbon atom is an oxygen atom that did not fulfill its purpose in the combustion reaction Likewise, any carbon atom that leaves the combustion chamber bonded to anything other than two oxygen atoms is taking potential energy with it. Competing combustion reactions in the cylinders of the diesel engine, such as the formation of NOx, strip the primary reaction of oxygen and rob the system of power. Even the combustion of hydrogen, as proposed by the HRM, removes reactive oxygen from the system. Oxides of nitrogen (NOx) are hazardous by-products of combustion reactions in internal combustion engines where atmospheric air is used to supply oxygen.

Approximately 78% of atmospheric air is nitrogen, so when the conditions are right for NOx formation, there is no shortage of a supply of nitrogen atoms. The major factors contributing to the formation of NOx molecules are temperature and residence time. Studies involving the HRM and Diesel Cycle engines have observed increases in NOx emissions. This is due to competitive reaction mechanisms. Multi-fuel (hydrogen and diesel-hydrocarbon) reactions generally support increased residence time of active oxygen as a result of competing side reactions and reversible intermediate products. This also means a greater threshold where the temperature is suited for this mechanism.

### Key Conclusion Points

It is clear that there are two divergent schools of practice within the Hydrogen Enhanced Combustion (HEC) community, both of which show promise in different internal combustion systems. The Hydrogen Replacement Model (HRM) has shown significant potential in Otto Cycle systems because the ignition source is independent of the fuel source. However, there are many variables which have made the HRM struggle within the Diesel Cycle applications. Therefore, there is presently no viable process for enhancing the efficiency and fuel versatility of a diesel internal combustion engine by introducing hydrogen gas into the diesel engine.

### SUMMARY OF THE INVENTION

The present Regulating A Hydrocarbon Combustion Process Using A Set Of Data Indicative Of Hydrocarbon Fuel Consumed Corresponding To A Monitored Engine Operating Characteristic process (termed “Combustion Management System” herein) models each hydrocarbon combustion application and supplies a product gas, comprising a dynamic mixture of nascent hydrogen (H) and oxygen (O), to the internal combustion engine to propagate the formation of hydroxide radicals (OH) and thereby to improve the level of completion of the hydrocarbon combustion reaction. Atomic hydrogen (or nascent hydrogen) is the species denoted by H (atomic), contrasted with di-hydrogen, the usual “hydrogen” (H₂) commonly involved in chemical reactions. Being monatomic, nascent hydrogen (H) atoms are much more reactive and, thus, a much more effective reducing agent than ordinary diatomic H₂ atoms. The Combustion Management System provides product gas volumetric requirement information and takes into account the engine style, primary torque requests, and hydrocarbon fuel consumption information to develop an operating system specific application that produces consistent measurable results. Stoichiometric models are used versus trial and error data obtained from running the engine on a dynomometer through various load and engine speed conditions, which saves time and money while insuring that each Combustion Management System application is adequate for its intended use.

The Combustion Management System effects increased combustive potential by utilizing a dynamic mixture of nascent hydrogen (H) and oxygen (O) to propagate the formation of hydroxide radicals (OH). Several fundamental differences between this and the Hydrogen Replacement Model (HRM), described above, are:
These hydroxide radicals (OH) are orders of magnitude more active oxidizing agents than O₂;
The thermodynamic model can be described in terms of order of completion of the hydrocarbon fuel combustion;
Nascent Hydrogen (H) is added in perfect stoichiometric balance with additional oxygen (O) to maintain the integrity of the internal combustion engine's Air Fuel Ratio design as measured by the exhaust gas concentration of oxygen; and
Much smaller volumes of hydrogen are required since the energetic gains are a function of additional carbon bonds broken in the hydrocarbon fuel.

The Combustion Management System uses electrochemistry to produce a product gas, which is a combination of nascent hydrogen (H) and oxygen (O). This product gas forms a dynamic equilibrium with the diatomic and free radical constituents yielding a gas with exceptionally high oxidative potential. The hybridized gas mixture is unique to the electrochemical process and cannot be replicated using compressed hydrogen gas (H₂) or fossil fuel reformation products.

Unlike the HRM, which introduces a competitive reaction into the internal combustion engine, this approach directly addresses the primary reaction driving the hydrocarbon combustion mechanism toward completion. This approach creates a twofold increase in the reactive tendency toward completion. Hydroxide radicals (OH) are lighter than the standard diatomic oxygen (O₂) being administered, which allows for greater diffusivity and an increased potential for oxidative continuance to supersede polymerization. Also, the higher oxidative potential of the hydroxide radicals (OH) allow for carbon chain cleaving reactions, thus creating more reactive sites on the hydrocarbon molecules and greater reaction distribution.

Fuel savings are achieved as a result of extracting more stored energy from each hydrocarbon molecule. Every carbon-carbon and carbon-hydrogen bond in the cylinders of the internal combustion engine represents stored energy that could be translated into mechanical work. By promoting a higher degree of oxidative completion, the Combustion Management System extracts more energy from the hydrocarbon fuel. Similarly, emissions of particulate matter, hydrocarbons, and carbon monoxide from the internal combustion engine are a direct result of this hydrocarbon combustion not propagating to completion. Therefore, furthering the combustive process has a direct and measurable impact on both fuel consumption and emissions reduction.

As noted above, polymerization is a problem in combustive reactions; and the primary causes of polymerization within an engine cylinder are fuel droplet size, turbulence, air composition, molecule size, and reaction mechanism. The Combustion Management System addresses each of these dynamics to ensure successful and consistent reductions. The product gas injection port not only administers the activated gas but also is designed to increase turbulence and ensure homogeneous mixing. Fuel injectors are modified or replaced to optimize droplet size and injection timing. The activated reaction mechanism generates more molecules of smaller size and greater separation. All of these factors combine to facilitate a near total reduction of particulate matter emissions.

The Combustion Management System is geared toward increasing the reactivity of the hydrocarbon fuel itself. By increasing the number of active carbon sites in the fuel, which is present in the cylinders of the internal combustion engine, the statistical probability of oxygen reacting in the desired fashion is dramatically improved. Also, the addition of nascent hydrogen (H) in stoichiometric balance with oxygen (O) nullifies the competition between the hydrogen (H) and carbon (C) for oxidation. Also, the creation of more active carbon sites reduces residence time of active oxygen and decreases the statistical probability that nitrogen and oxygen will collide during the optimum temperature threshold. Reaction rate reductions also serve to limit the timeframe where NOx formation is energetically feasible.

The Combustion Management System is a more universally applicable model because it is based on a principle of directly affecting the primary reaction rather than introducing a competing reaction mechanism. The Combustion Management System model requires a lower volume of gas injection to achieve results. This system simultaneously affects fuel consumption and emissions reductions via the same mechanism. This process works for all oxidative processes with respect to hydrocarbon molecules.

### BRIEF DESCRIPTION OF THE DRAWINGS

FIG. 1A illustrates, in tabular form, the operation of the Combustion Management System; and FIG. 1B illustrates a Sankey Diagram of the combustion process controlled by the Combustion Management System;

FIG. 2 illustrates, in block diagram form, the typical elements of one embodiment of the Combustion Management System;

FIG. 3 illustrates a typical configuration of the metal plates contained in the Reactor Cell of the Combustion Management System;

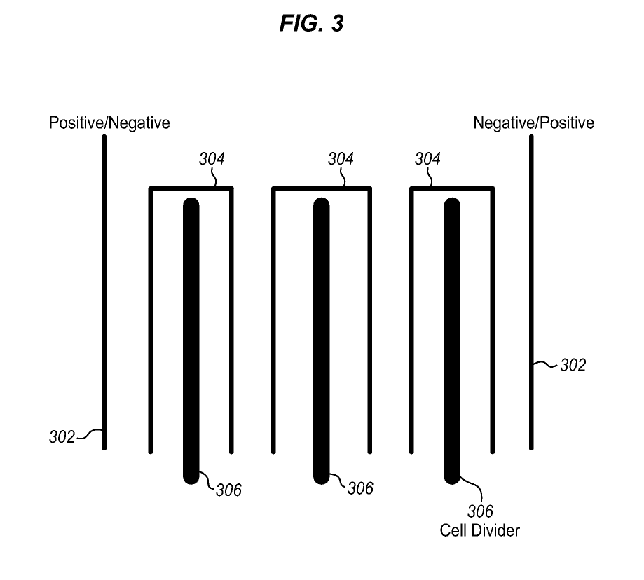

FIG. 4 illustrates the typical electrical current spread on typical plate geometries in the Reactor Cell of the Combustion Management System;

FIG. 5 illustrates a typical gas scrubber for use in the Combustion Management System; and

FIG. 6 illustrates, in block diagram form, the Combustion Management System as installed with a typical internal combustion engine.

### DETAILED DESCRIPTION OF THE INVENTION

### Internal Combustion Engines

A diesel engine is an internal combustion engine that uses the heat generated by the compression of the atmospheric air in the combustion chamber to initiate ignition which burns the diesel fuel, which is injected into the combustion chamber during the final stage of compression. This is in contrast to a gasoline engine, which uses the Otto Cycle, in which an air-fuel mixture, located in the combustion chamber and compressed by a piston, is ignited by a spark plug. The gasoline engine has a thermal efficiency (the conversion of fuel into work) of 8% or 9%, while the diesel engine has a thermal efficiency of about 30%.

In the diesel engine, only air is initially introduced into the combustion chamber. The air then is compressed with a compression ratio typically between 15:1 and 22:1, resulting into a 40-bar (4.0 MPa; 580 psi) pressure compared to 8 to 14 bars (0.80 to 1.4 MPa) (about 200 psi) in the gasoline engine. This high compression of the diesel engine heats the air to approximately 550° C. (1,022° F.). At about this moment, fuel is injected directly into the compressed air in the combustion chamber. This may be into a void (typically toroidal in shape) in the top of the piston or a pre-chamber depending upon the design of the diesel engine. The fuel injector ensures that the fuel is broken down into small droplets and that the fuel is distributed evenly. The heat of the compressed air vaporizes fuel from the surface of the droplets. The vapour then is ignited by the heat from the compressed air in the combustion chamber, the droplets continue to vaporize from their surfaces and burn, getting smaller, until all of the fuel in the droplets has been burned. The start of vaporization causes a delay period during ignition, i.e., the characteristic diesel knocking sound as the vapor reaches ignition temperature, and causes an abrupt increase in pressure above the piston. The rapid expansion of combustion gases then drives the piston downward, supplying power to the engine crankshaft.

As well as the high level of compression which allows combustion to take place without a separate ignition system, a high compression ratio greatly increases the engine's efficiency. Increasing the compression ratio in a spark-ignition engine where fuel and air are mixed before entry to the cylinder is limited by the need to prevent damaging pre-ignition. Since only air is compressed in a diesel engine, and fuel is not introduced into the cylinder until shortly before top dead centre (TDC), premature detonation is not an issue and compression ratios are much higher. Advancing the start of injection (injecting before the piston reaches TDC) results in higher in-cylinder pressure and temperature, and higher efficiency, but also results in elevated engine noise and increased oxides of nitrogen (NOx) emissions due to higher combustion temperatures. Delaying the start of injection causes incomplete combustion, reduced fuel efficiency, and an increase in exhaust smoke, containing a considerable amount of particulate matter and unburned hydrocarbons.

In addition, diesels develop maximum horsepower and efficiency over a wide range of speeds. Diesel engines typically are also equipped with a turbocharger, which uses exhaust gases from the diesel engine to drive a turbine that supplies highly compressed air to rapidly remove (scavenge) exhaust gases from the cylinders. This increases the compression in the cylinders and helps to cool the cylinders and cylinder heads. The increased compression in the cylinder results in higher efficiency in burning the fuel, and hence, more horsepower. A turbocharger can increase the power output of a diesel engine by 30% to 50%, depending on various factors.

### System Application

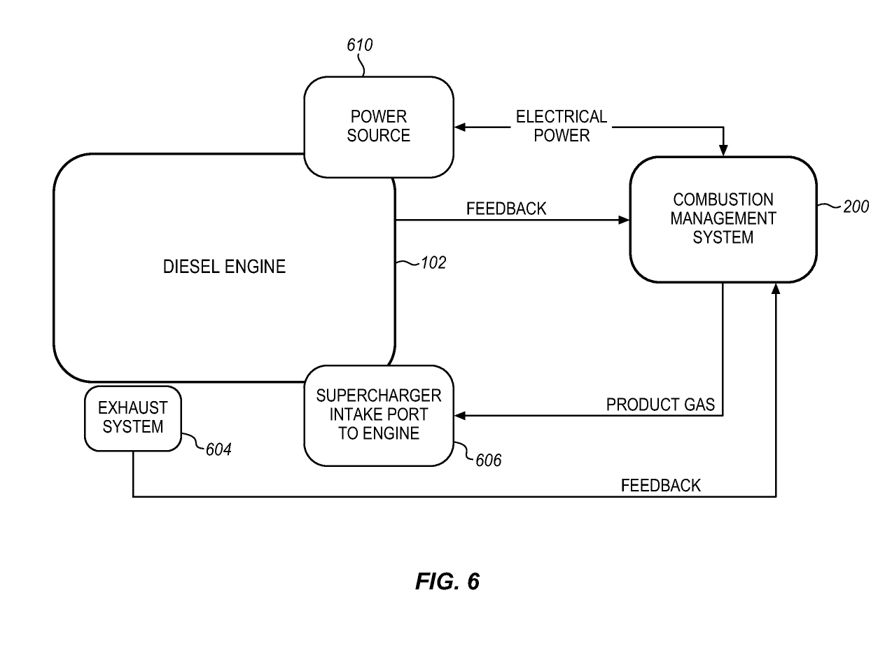

FIG. 6 illustrates, in block diagram form, Combustion Management System 200 as installed in an existing internal combustion engine 602, as an example of the use of the Combustion Management System 200 with a hydrocarbon combustion process. The internal combustion engine 602 is equipped with standard components consisting of an exhaust system 604, an atmospheric air intake supercharger 606, and an electrical power generator 610. The Combustion Management System 200 is powered by electrical energy generated by the electric power generator 610 and produces a product gas PG which is mixed with the incoming atmospheric air at the supercharger 606 and injected into the internal combustion engine 602 in well-known fashion.

### Combustion Management System

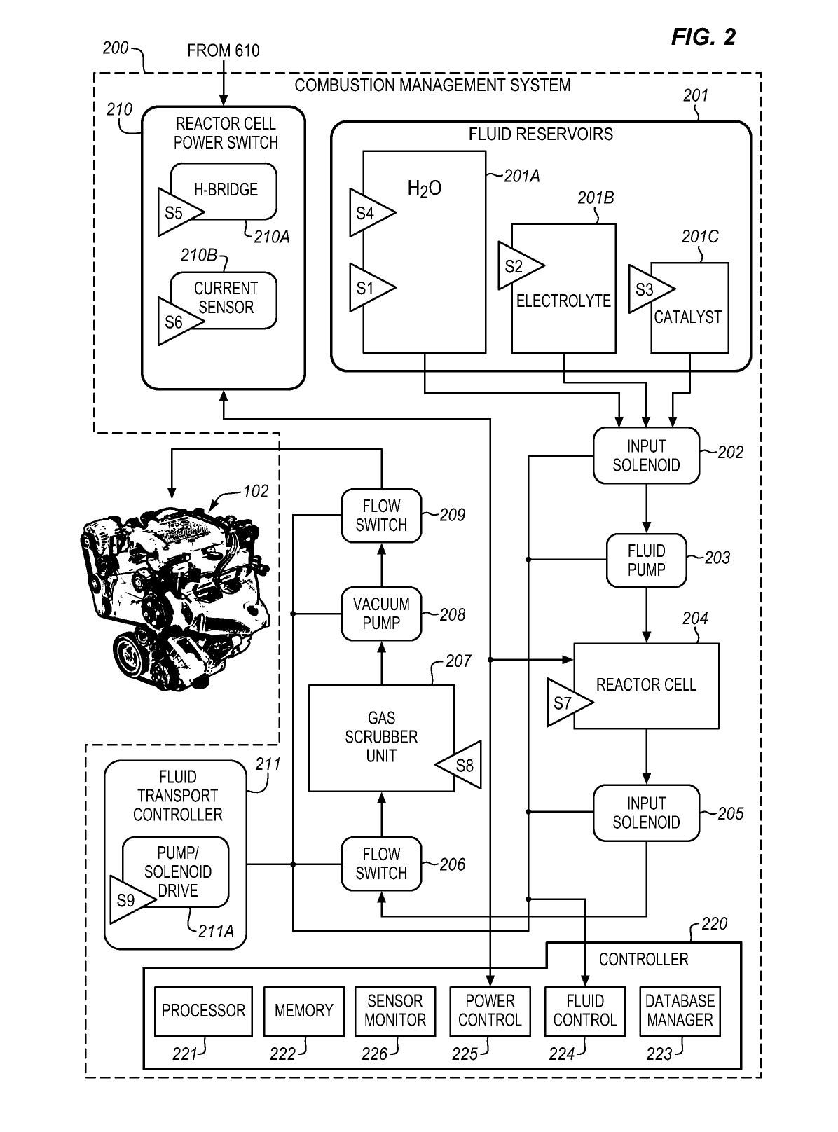

FIG. 2 illustrates, in block diagram form, the typical elements of one embodiment of Combustion Management System 200. A set of fluid reservoirs 201 is provided to store a plurality of fluids, each in a designated one of reservoirs 201A-201C. A first reservoir 201A stores a quantity of water, which is used to dissociate monatomic Hydrogen (H) and monatomic Oxygen (O); a second reservoir 201B is used to store an electrolyte, which is used in Reactor Cell 204 as described below; and a third reservoir 201C is used to store a catalyst, which is used to enhance the reactions in Reactor Cell 204 as described below. Each of the reservoirs 201A-201C includes a corresponding fluid level sensor S1-S4, as described below, to provide indications of the fluid level in each reservoir 201A-201C.

### Controller

The Controller 220 includes hardware and software specifically designed to manage the Combustion Management System 200 functionality and safety protocol. Controller 220 includes a Processor 221 which monitors and controls the major logic components, including the capacity to manage the multiple iterations of the Reactor Cell Power Switch 210. Controller 220 also manages fluid transport, user interface, data logging, and real time remote access functions.

The development of a workable thermodynamic model is the first step in the development of a viable product. The next critical consideration is understanding the mechanical system into which the product is integrated and identifying the key variables pertinent to the success of the integration. Fuel delivery, sensory control loops, fuel consumption rates, duty cycle, transient state dynamics, and mean RPMs are just a few of the variables to consider when preparing to integrate. Presently, the Combustion Management System 200 is optimized for low RPM, high-duty-cycle engines. Long operating times in steady state conditions and limited feedback loop management systems provide for a simpler interface than the dynamic and stringently managed systems seen in the higher RPM and lower-duty-cycle systems.

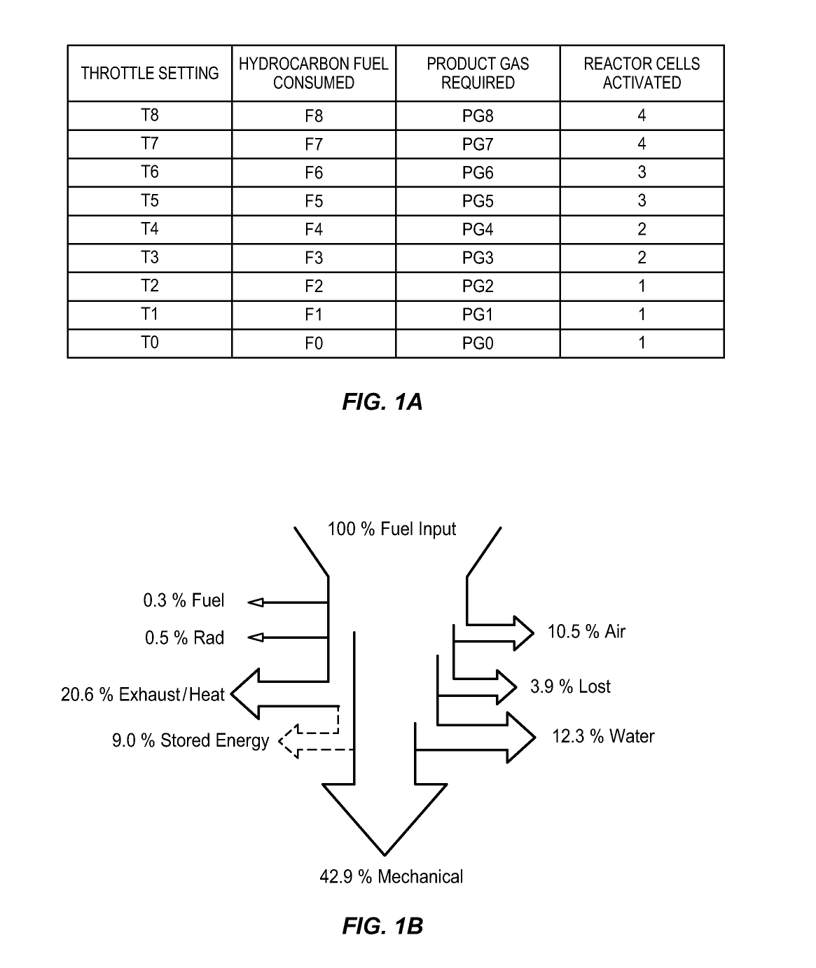

FIG. 1A illustrates, in tabular form, the operation of the Combustion Management System 200. The Combustion Management System 200 makes use of a hydrocarbon combustion process model, stored in memory 222, which determines the volume of a product gas PG required for a volume of hydrocarbon fuel F which is required to improve the level of completion of the hydrocarbon fuel combustion process. Also provided is a mapping of the number of Reactor Cells 204 that need to be active in order to provide an adequate amount of the product gas PG, as determined from this chart. There is shown a column labelled “Throttle Setting” which is one of the simple metrics which can be associated with a volume or range of volumes of hydrocarbon fuel which is consumed by the hydrocarbon fuel consuming process. There are a number of operating characteristics which can be used for this purpose and they include, but are not limited to: engine Revolutions Per Minute, engine turbocharger Revolutions Per Minute, internal diagnostic array of the engine, exhaust flow of the combustion by-products, engine cylinder pressure, and the like. Thus, an engine operating characteristic is indicative of a corresponding hydrocarbon fuel consumption volume, which can actually be a range of hydrocarbon fuel volumes, since the engine operating characteristic may not be a simple immutable number but can consist of a “level” of operation. For example, the throttle setting T is indicative of a demand for power from the engine, but the throttle setting can be a continuous variable; and a particular throttle setting T3 could be indicative of a request which falls between predetermined limits on a range of the continuum of throttle settings.

The product gas volume also is indicative of a required volume of product gas PG for the volume of hydrocarbon fuel associated with a selected throttle setting (or other measured engine operating characteristic). The number of Reactor Cells required to supply this volume of product gas PG is selected to provide ample reserve to account for changes in the demand for product gas PG.

### Reactor Cell Power Control and Power Switch

Reactor Cell Power Control 225 optimizes the electrochemical reaction in Reactor Cell 204 within the parameters of the Combustion Management System 200. This component manages the extremely high current utilized by the Reactor Cell 204. Current is monitored using current sensor 210A, and decisions are made by the Reactor Cell Power Control 225 as a function of the present request for current received from Reactor Cell 204. A square wave signal is generated by the Reactor Cell Power Switch 210 at frequencies which optimize the electrochemical reaction in Reactor Cell 204, while the duty cycle of the square wave signal is adjusted to limit the effective current draw with sensitivity to the capacitive effect of the reaction. An H-bridge 210A, which is an electronic circuit which enables a voltage to be applied across a load in either direction, is utilized to reverse polarity across the terminals of the Reactor Cell 204 with regularity to reduce migration, again with special accommodations for the Reactor Cell's capacitance.

The following is a list of typical logic considerations performed by the Reactor Cell Power Control 225:
1. Measure electric current flowing through the electrodes of Reactor Cell 204;
2. Communicate pump activation requests to Fluid Control Module 224: In the event that sensors S1-S4 indicate a need for addition of water from reservoir 201A, concentrated electrolyte from reservoir 201B, or catalyst from reservoir 201C, the request is communicated to Fluid Control Module 224 for fluid transport management;
3. Communicate shut-down status of a Reactor Cell 204 to Reactor Cell Power Switch 210: When Reactor Cells 204 are linked in parallel, a failure of one individual Reactor Cell 204 does not require the entire Combustion Management System 200 to shut down; when Reactor Cells 204 are linked in series, the entire series block is deactivated. Any shut-down condition is communicated to an operator and logged with a master control database 223 located in Controller 220;
4. Respond to requests for information: In the event that no alerts are generated by the sensor array S1-S9, the Sensor Monitor 226 of the Controller 220 surveys the status of each sensor for data logging;
5. Maintain watchdog circuit: Reactor Cell Power Control 225 anticipates communication with Controller 220 at regular intervals, and goes into an error mode if communication cannot be confirmed;
6. Monitor cell liquid level: A sensor S7 is built into the structure of the Reactor Cell 204 to monitor the fluid at the minimum desired level; the sensor signal is “de-bounced”, meaning that a low level indication must persist for a predetermined time before it is acted upon to compensate for the effects of normal fluid motions in a moving application;
7. Monitor the printed circuit board temperature in the vicinity of the H-bridge 210A via temperature sensor S6: High temperatures can damage the circuitry; and high temperatures are likely an indication of a larger functional issue which suggests the need for further inspection; and
8. Monitor supply voltage: If supply voltage begins to drop, the power source 610 is not providing sufficient power to support the operation of the Reactor Cell 204 as well as the internal combustion engine's operating systems; a drop of 1.5 V or more is an indication that the Combustion Management System 200 needs to shut down until the Combustion Management System 200 can be inspected.
   The Controller 220 responds to received fluid level indications by activating selected ones of the input solenoids 202 to enable fluid flows from reservoirs 201A-201C to Reactor Cells 204 as provided by associated fluid pumps 203.

### Reactor Cells

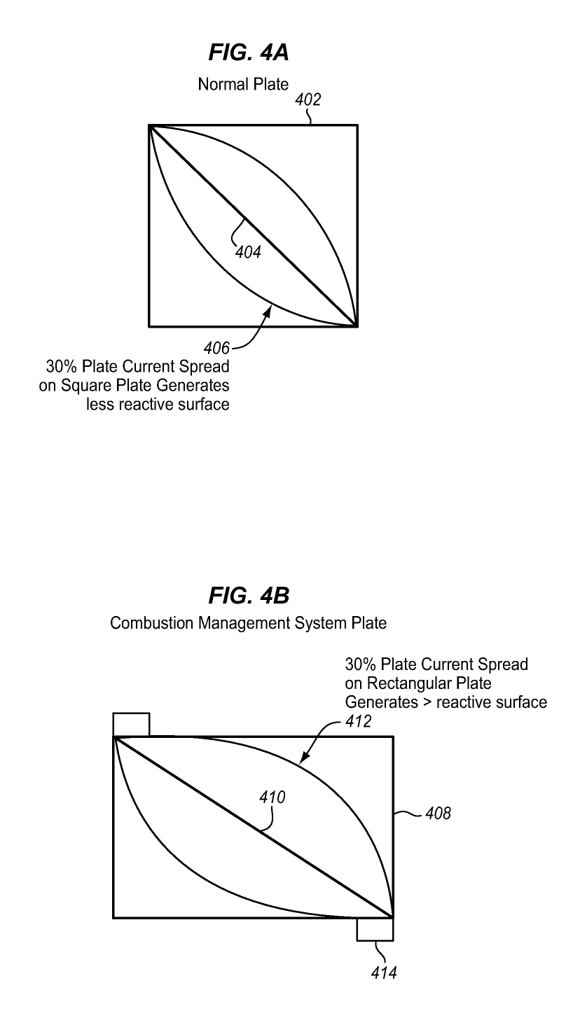

FIG. 4 illustrates a typical configuration of the metal plates contained in the Reactor Cell 204 of the Combustion Management System 200. The design utilizes bridged pair plates 404 with insulating partitions dividing each pair 406 and an entry electrode 402. Plate design and configuration are based on a combination of electrochemical standards and physical electron transport process dynamics.

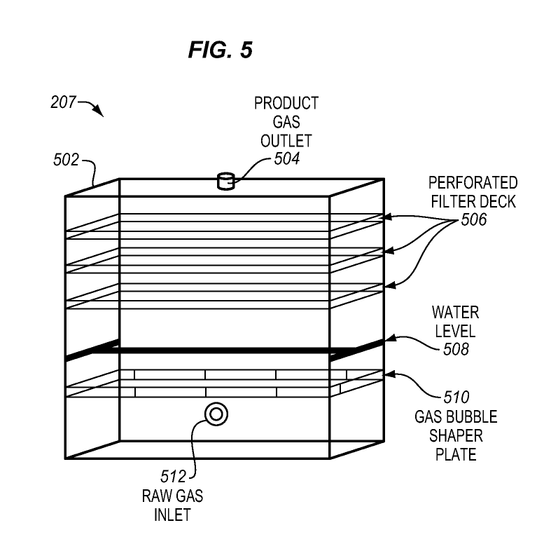

FIG. 5 illustrates the typical electrical current spread on typical plate geometries in Reactor Cell 204 of the Combustion Management System 200 and is an example of current dispersion optimization based on 30% electron drift (506, 512) along the diagonal (504, 510). The square plate (502) has a great percentage of surface area that does not achieve enough current to propagate reasonable reaction efficiency. By changing the plate dimensions to a 3:1 ratio (508), such as 2″×6″, the current effective area is a much greater percentage of the surface area of the plate. Maximizing current saturation has the following effects: more electrons propagating reaction, increased reactor efficiency, and lower heat generation.

Electrochemically, a 1.23V potential will break the Hydrogen-Oxygen bonding in water. In a twelve-volt system, this corresponds to ten plate pairs in series, with twenty plate pairs for a twenty-four volt system configuration. The plates are part of an induced series configuration propagating the current through an alternating sequence of straight shorts and electrolytic media connection. In one implementation of the Combustion Management System 200, nonconductive dividers are used to ensure proper charge orientation and distribution.

In contrast to conventional systems, and considering the path by which the current flows through stainless steel plates, when the primary current was oriented along the diagonal of the plate, approximately 30% swelling occurs at the center. In an effort to optimize effective plate charge, coverage plates with a 3:1 dimensional ratio were chosen. Plates are fixed in Reactor Cells 204 in such a manner that they are allowed to vibrate, which optimizes the release of product gases in the form of bubbles from the surface of the plates.

The Reactor Cells 204 contain, for example, twenty plate pairs. The pairs are separated into four sets of six pairs, which are individually connected in series. The design allows for two sets to be connected in parallel for twelve-volt applications and in series for twenty-four volt systems. Furthermore, entire Reactor Cells 204 may be linked in either series or parallel so a wide array of varying voltage applications can be supported in optimal fashion. In other words, in the case of a heavy duty twelve-volt engine application, four Reactor Cells 204 configured for twelve volts can be linked in parallel, thus providing 96 pairs of reactive plates with a 1.9-volt potential. Furthermore, for a 74-volt system, such as a railroad locomotive, one and a half cells configured for twenty-four volts can be connected in series to offer 36 reactive pairs of the same potential.

In the end product, transport of caustic liquids and combustible gasses with high diffusion coefficients are intrinsic to the Combustion Management System 200. Special attention is paid to fitting seals and transfer efficiency. Hose barbs are molded into the components with specialized molding processes.

Product gases PG are extracted from the Reactor Cells 204 through output solenoid 205 and flow switch 206, then pulled through the gas scrubber 207 by a vacuum pump 208. The Combustion Management System product gas PG, as noted above, is a mixture of nascent hydrogen (H) and oxygen (O) in dynamic equilibrium with hydroxide radicals, and diatomic oxygen and hydrogen, (termed “oxyhydrogen” herein) produced via an electrolytic reaction in the reaction cells, part of the physical Combustion Management System (200).

### Reactor Cell Implementation

Electrically, the plate configuration of the Reactor Cell 204 comprises an inductive series circuit of pairs of plates, with each plate being one half of a reactive pair of plates. The inter-plate (reaction specific) voltage is a function of the number of pairs of plates between the contact electrodes of the Reactor Cell 204:

Inter-Plate Voltage=Supply Voltage/# of Reactive Pairs of Plates

The optimum voltage is dependent on the reaction, and a typical value is between 1.8V and 2.1V. This configuration is self correcting for reaction propagation.

Specific example:

| | |
|---|---|
| Reaction Potential | 1.8 V |
| Input Potential | 24 V |
| Reactive Pairs | 30 |
| Per Pair Theoretical | 0.8 V/pair of plates 44% of required |
| Voltage | potential |
| Net result | 13 pairs of plates carry out the |
| | reaction; the other 17 pairs of plates |
| | behave as a salt bridge to transport |
| | the current with minimum voltage drop. |

The spacing of the plates is critical yet reaction specific, and 0.05 to 0.07 inches is optimum for this particular reaction. In addition, the alternation of the bridge strap position promotes current propagation along the diagonal of the plates.

### Plate Construction and Design

The caustic nature of the electrolyte used in the Reactor Cell 204 necessitates the use of inert electrodes. Platinum is the preferred electrode material or coating in industrial applications, since it is highly inert and has great electrical conductive properties; however, it is an extremely expensive material. Molybdenum is a close second choice for many of the same reasons as noted above for Platinum. An alternative material is 316 L stainless steel, which is highly inert, much less expensive than either Platinum or Molybdenum, and is readily available. A further alternative material is nanoparticle impregnated carbon fibers, which have a low cost of manufacture, are light weight, dramatically increase surface area and gas releasing properties, an ability to engineer current dispersion properties, improved efficiency, and zero atomic drift and dissociation over time.

### Product Gas Scrubber

FIG. 2 illustrates a typical product gas PG scrubber 207 for use in the Combustion Management System 200, which is a component that purifies the product gas PG prior to delivery to an internal combustion engine 602. The product gas PG scrubber 207 further provides a flashback arrestor. The product gas PG scrubber 207 removes collective moisture such that there is 5% or less moisture in the product gas PG administered to the internal combustion engine 602. The functional design of product gas PG scrubber 207 is a hybrid of impingement plate and irrigated filter wet scrubber models. The product gas PG scrubber 207 uses a combination of absorption and Brownian diffusion modes to extract particulate contaminants as well as excited molecular vapor contamination. Product gas PG transport is promoted by a vacuum pump 208 connected to the product gas PG scrubber's output port regulating a 5 to 13 L/min output flow (flow varies based on production capabilities of an application based on Reactor Cell 204). Contaminated and vapour-saturated product gas PG enters the product gas PG scrubber 207 at the bottom of the chamber where it is immediately forced through a diffusion plate oriented 90° to the input stream. The diffusion plate serves to decrease the velocity of the incoming gas stream as well as to begin separation via product diffraction. The constituents of the product gas PG, being of different mass experience, different acceleration of entry into the fluid extraction membrane. As surface tension of the water shapes the gas into a bubble, the individual molecules strike the interfacial wall and, depending on solubility, size, and charge, are absorbed or deflected back into the bubble. In the time it takes for the bubble to pass the 95.25 mm to the surface, there is an average of 40% molecular diffusion taken out of the bubble.

The product gas PG scrubber 207 is a reservoir comprised of one input port and two output ports, a level sensor, and four gas diffusion plates. A vacuum pump is connected to the output port at the top of the reservoir. The Reactor Cell product gas PG output ports are connected to the input port at the base of the reservoir. The reservoir contains an electrolyte fluid, which acts as a filter and a separator. Product gasses are forced via the vacuum produced by the pump through the primary diffusion plate, traveling through the fluid in the form of small bubbles. Surface area and bubble size are a primary consideration because this media separation allows the system to collect/scavenge impurities for return to the liquid medium. The three diffusion plates at the top of the reservoir have offset porting and act as a condensation matrix. During operation, the liquid level in the reservoir will rise, which is monitored by the level switch. The secondary output port is attached to a liquid pump which extracts excess liquid and returns it to the reaction supply. The product gas PG scrubber fluid is the same as the electrolyte in the cells.

### Fluid Transport System

The fluid transport system is responsible for maintaining proper electrolyte levels in the Reactor Cells 204 as well as ensuring proper extraction and delivery of product gases PG. A liquid pump and solenoid valve manifold transport water, concentrated electrolyte, and catalyst to designated compartments. A system of level sensors and control logic directs operations, as well as monitors functioning of components.

All liquid media is filled and stored in one or more reservoirs—unique to each particular application. For example, a short haul operating system where the truck returns to a base at the end of every day generally can function on a five-gallon water tank that can be topped off at the beginning of each day, whereas a locomotive engine that runs for many days at a time without reaching a servicing base will likely require a much larger water reservoir. Storage levels are set according to the duty cycle of the engine the unit to which it is attached. In one implementation, filling is a “no touch” pump driven operation. For instance, the reservoir may be connected to the solenoid manifold and liquid pump. The manifold is connected to other components of the system to manage fluid flow between the components. Level sensors in each component work with the manifold and pump to maintain proper levels in each unit during operation. In one implementation, the process control logic contains de-bouncing algorithms, event timers, alerts, and corresponding event handlers (e.g., to provide information regarding proper functioning of the liquid system, to automatically shut down in the event of a failure or procedural anomaly, etc.) and/or so on. A basic de-bouncing algorithm will require the reed switch to trigger for a full 5 seconds to insure that the trigger event wasn't a product of an instantaneous event such as bouncing or sloshing.

### Air Interface

Produced gas mixes into compressed air of the turbo line. The delivery system is a venturi effect inducer port installed directly into the turbo line of the engine system. In order to achieve consistent success, the following considerations are characterized for each engine type:
Negative air pressure at injection;
Homogenous mixing;
Fuel injection timing recalibration;
In common rail, achievement of surplus hydrogen for all torque requests; and
Interface with CAN Bus in newer engine types.

### Fuel Interface

The fuel interface method mixes the product gases PG directly into the combustive fuel prior to injection. In one implementation, the system utilizes a venturi effect mixing apparatus to dissolve the product gas PG components into the diesel fuel in the line. Due to the low solubility of oxygen, the un-dissolved gas is extracted using a fluid/gas extractor component installed pre-fuel filter. The extracted gas is administered to the air supply using the air interface component. Fuel interface technology is novel as compared to the Hydrogen Enhanced Combustion state of the art. To ensure repeatable success of this method, the following considerations are achieved:
Hydrogen is thoroughly dissolved in fuel—This is achieved via a stationary mixing tube, the application-specific design which is laboratory proven for maximum threshold values prior to installation;
Any un-dissolved gas is extracted prior to entering common rail—A special gas phase separator is added to the fuel line before the common rail or injector housing;
Stable at high temperatures and pressures;
Hydrogen is free upon injection;
5% molar hydrogen to fuel—A dosing pump is calibrated to application-specific fuel line requirements;
Extracted gas (un-dissolved oxygen) is injected into the air supply; and
Recirculated fuel is stable (no buildup of hydrogen in fuel tank).

### Electrolyte Chemistry

The chemical composition of the electrolyte determines the rate, efficiency, and product of the electrolysis. KOH is the electrolytic catalyst of choice in the Hydrogen Enhanced Combustion (HEC) market, although concentrations vary from company to company. The Combustion Management System technology utilizes a 1.5% molar concentration of KOH, which is a strong Base (alkaline). Theoretically, any alkaline can serve the primary function, but other characteristics of the alkaline elements make them unfavorable as catalysts in this environment. The reaction equation is multi functional. KOH dissociates in water to form K_{+aq}+OH_{-aq}. These components, being catalytic, have no place in the actual half reactions. Combustion Management System 108 also utilizes the wetting properties of a non-foaming surfactant as a process catalyst in specialized applications. Surfactant catalysis provides energetic favorability and promotion of a hydrogen specific product gas.

HEC technology utilizes catalysis as a promoter of electrochemical efficiency and increased product gas PG production by reducing the enthalpy of decomposition. Proper electrolyte chemistry promotes current transfer between electrodes. A good electrolytic catalyst also facilitates extraction of product gas PG atoms from the reactive electrode.

### Overview Regarding Hydrogen Enhanced Combustion Gains

The administration of a hydrogen/oxygen gas mixture fundamentally improves the overall combustion reaction efficiency by driving the reaction to a higher level of completion. This improvement translates into a significant increase in energy released and decreased fuel requirement.

Consider the standard Diesel engine as simply a reaction chamber for the combustion of Diesel fuel. In this paradigm, the system consists of the input combustion fuel, the input atmospheric air, the compressive promotion of auto-ignition, and the exhaust. The combustion of carbon chains in the cylinders of the diesel engine is an oxidation reaction that, from an energetic analysis, when allowed to reach completion, results in CO₂ and H₂O. Any molecules in the exhaust gas mixture other than these two can be classified as caused by impurities or failure to achieve reaction completion. Present emissions analyzers test for the following:
Hydrocarbons
Carbon Monoxide
Carbon Dioxide
Nitrogen Oxides
Oxygen
   Referring to the above list, the first three items can be classified as a measure of the degree of the combustion. Hydrocarbons, having the lowest degree of decomposition, represent stored energy that has not been transferred to the drive train system. The combustion of carbon molecules described in its simplest form is a decomposition of molecules such that energy is derived from the breaking of covalent bonds. The following is a list of bond energies for carbon molecules:
C—C Bond energy 348 kJ/mol
C═C Bond Energy 614 kJ/mol
C≡C Bond Energy 839 kJ/mol
C—H Bond Energy 413 kJ/mol
   Accordingly, it is easy to see by this list that every carbon bond that is not broken in the hydrocarbons that are present in the exhaust represents a sizeable measure of stored energy that is being wasted. It is this wasted energy that Hydrogen Enhanced Combustion (HEC) is geared at capturing. The second measured component, CO, is a result of depletion of reactive oxygen in the vicinity of decomposed carbon atoms. Carbon monoxide has a higher enthalpy of formation (−110.5 kJ/mol) than carbon dioxide (−393.5 kJ/mol), further depleting the energy available for transfer to the drive train.

There is much discussion in engineering circles regarding the potential for efficiency gains with hydrogen administration. The description in the following section titled “Computational Analysis” does not in any way, shape, or form seek to argue against this industry-wide accepted value. Rather, it delves deeper into the mechanics of this combustion to paint a more accurate picture of what this accepted efficiency truly means, as well as to illustrate the potential for much greater gains.

Given the accepted principles and concrete measured values, they are used to construct a more complete picture of the system's combustive process and assess where the measured gains actually come from. The data used for this following example were measured values for a Detroit Diesel 71-2 Genset system. The fundamental concept is as follows. The system is deriving power from the combustion of diesel fuel (for the sake of these calculations represented as Cetane C₆H₁₄). The reaction occurring is 4C₁₂H₂₃+71O₂→48CO₂+46H₂O. The test measured the composition of the exhaust gas as well as the weight of the fuel being administered. Allowances were made for the carbon content of the air component of the input. The CO₂ component is compared to the input carbon as a direct measure of the percentage to which the combustion reaction has been propagated to its completion.

Computational Analysis Regarding Tests Performed On A Detroit Diesel
71-2 Engine With The Present Combustion Management System

| The Computational Model: | |
|---|---|
| Reaction: | 4C₁₂H₂₃ + 71O₂ → 48CO₂ + 46H₂O |
| Model Specific Parameters: | |
| 100% efficiency: | 4C₁₂H₂₃ + 71O₂ → 48CO₂ + 46H₂O |
| | = −1.42 × 10⁵ kJ/gal |
| | = 39.4 kWh/gal, since 1 kWh = 3.6 × 10³ kJ |
| 97% efficiency argument: | = .97 * (−1.42 × 10⁵) kJ/gal |
| | =−1.38 × 10⁵ kJ/gal |
| | = 38.27 kWh/gal |
| Dataset: | |
| Baseline: | |
| Consumption | = 1.585 gal/h |
| Theoretical output | = 62.45 kW |
| Genset Load: | = 21.46 kW |
| Output Efficiency | = 34% |
| Combustion Management | |
| System: | |
| Consumption | = 1.11 gal/h |
| Theoretical output | = 43.69 kW |
| Genset Load | = 21.87 kW |
| Output Efficiency | = 50.1% |

Discussion regarding 16.1% output efficiency increase:

There are three major factors affecting the output efficiency of the two-stroke diesel genset model: combustive, mechanical, and thermal. The Combustion Management System application affects all three to produce the 16.1% observed gains.

### Combustive:

The Combustion Management System has effected a 73% reduction in hydrocarbon emissions and a 4% reduction in carbon dioxide while burning 17% less fuel and supplying 1.91% greater load. The argument is that these results require clarification as to their feasibility. We will start by analyzing combustive energetics.

Diesel fuel (model)=C₁₂H₂₃

Density=0.85 kg/L

Molecular Weight=0.167 kg/mol=5.988 mol/kg

### Conversion:

x Gal/h*3.785 L/Gal*0.85 kg/L*5.988 mol/kg*12 mol C/mol C₁₂H₂₃=mol C/h
x Gal/h*231.179 mol C/h=mol C/h

### Composition Model

CO₂ accounts for 49% of combustion product
Air Fuel Ratio (AFR) (in this case measured lb air:lb fuel)
   Air properties: Density 1.2 g/L=0.010 lb/Gal
   24.79 L/mol=>6.549 gal/mol=>0.0655 lb/mol
   20.95% O₂ & 0.038% CO₂
Baseline: 51.16 lb air/lb fuel*11.9 lb fuel/hr=608.84 lb air/hr=>9295.27 mol air+1947 mol O₂+4 mol CO₂
Combustion Management System: 52.7 lb air/lb fuel*9.9 lb fuel/hr=521.73 lb air/hr=>7965.34 mol air+1669 mol O₂+3 mol CO₂

Conservation of mass states that total mass in must equal total mass out

| | | Combustion |
|---|---|---|
| | Baseline | Management System |
| Mass in: | 620.74 | 531.63 |
| Exhaust Gas Composition: | | |
| HC (ppm) | 102.75 | 27.75 |
| CO₂ (%) | 4.25 | 4.08 |
| NOₓ (ppm) | 549.25 | 282 |
| Diesel Fuel Input: | | |
| Gal/h | 1.585 | 1.11 |
| mol C/h | 366.42 | 256.61 |

CO₂ component in exhaust: (CO₂=44 g/mol=>0.097 lb/mol=>10.31 mol/lb)
Baseline: 4.25%=>26.38 lb/h*10.31 mol/lb=271.96 mol/h+4 mol/h in air

excess C=90.46 mol/h
75% combustive efficiency or 25% incomplete burn
   Combustion Management System: 4.08%=>21.65 lb/h*10.31 mol/lb=223.63 mol/h+3 mol/hr in air

excess C=29.98 mol/h
88% combustive efficiency or 12% incomplete burn
   Combustive gain 13%

The following is a brief discussion regarding the 3.1% gain not accounted for in the combustive analysis.

### Thermal:

The Combustion Management System reduces thermal efficiency losses by reducing combustion temperatures, which in turn reduces cylinder head and exhaust temperatures.

### Further Claim Bases Computation:

Hydrocarbon emissions are a mixture ranging from unburnt fuel C₁₂H₂₃ to methane CH₄. In this example, a mean hydrocarbon is used such as hexane C₆H₁₄. For the Baseline, this would mean 15 mol/h hexane in exhaust. The 13% gain in combustive completion can be represented as the burning of 2 mol C₆H₁₄:

2C₆H₁₄+19O₂→12CO₂+14H₂O=−5835.76 kJ/mol

For the two mol considered in this computation, the energetic gain is 11671.52 kJ/h or 3.24 kW.

### Recoverable Losses:

### The Paradigm Regarding The Calculations:

The calculations are strictly a consumptive calculation relating the carbon put into the system versus the carbon in all forms other than CO, coming out of the system. This number gives an overall conversion efficiency for the combustion.

### Unavoidable Assumptions:

The following is a list of assumptions which are deemed unavoidable due to the level of complexity and inconsistency in the specific composition of diesel fuel and atmospheric air:
Assumed composition of diesel fuel: C₁₂H₂₃
Assumed CO₂ component in atmospheric air: 0.033%
   These assumptions, although generally accepted, will limit the accuracy of the computation to a small degree.

### Limitations of the Computational Analysis:

This set of computations is designed to establish a fundamental agreement that there is a non-complete combustion process in the cylinder. The computational analysis is designed to quantify the degree to which the combustion achieves completion. This analysis describes the percentage of input carbon which is completely oxidized (decomposed to CO₂) in terms of that which is not (all other carbon derivatives). There is not an available dataset which provides sufficient information regarding the true molecular composition of the hydrocarbon (HC) and particulate (PT) constituents, so a true energetic quantification cannot be produced.

### With Respect to the Requested Data:

The fuel input relative to the exhaust is a critical dataset with respect to the computation at hand. This is the information upon which the entire computation is predicated and must be as accurate as possible in order to produce a reasonable solution.

The AFR was requested as a form of checks and balances to substantiate the computational result. For that reason, calculating the AFR based on the oxygen in the exhaust produces a circular argument.

### In Reference to the Sankey Diagram of FIG. 1B

As described herein, this computational analysis is not a quantitative energetic analysis, since such an energetic discussion would be subject to a large margin of error. For that reason, it is not possible or pertinent to produce such a diagram with respect to these computations.

### Measured Values and Computational Parameters:

These are the values from which all computation and conversions will be based:

| | |
|---|---|
| Delivered Hp of the Engine (kW): | 1472 |
| Measured Exhaust (composite g/kWh): | |
| CO: | 0.51 |
| Molecular Weight: | 28 g/mol C |
| HC: | 0.91 |
| Molecular Weight: | 14 g/mol C |
| PT: | 0.08 |
| Molecular Weight: | 14 g/mol C |
| Fuel definition parameters: | |
| Fuel model: | C₁₂H₂₃ |
| Molecular Weight (kg/mol): | 0.167 (Defined Value) |
| Fuel Density (kg/L): | 0.85 (Defined Value) |
| Heat of Combustion (MJ/kg): | 44.86 (Measured) |
| Fuel Input (g/kWh): | 203.3 (From ABC) |
| CH₄ Heat of Combustion (kJ/mol): | 802.34 (Defined Value) |
| CO vs. CO₂Formation Energy (kJ/mol): | 283 (Defined Value) |
| Conversion parameters: | |
| 0.2778 kWh | → 1 MJ |

### Overall Engine Efficiency:

The first set of computations regard the overall efficiency of the system in terms of potential energy administered versus derived power.

Fuel In
203.3 g/kWh
0.2033 kg/kWh
Measured Heat of Combustion
44.86 MJ/kg × 0.2778 kWh → 12.462 kWh/kg
Energetic Analysis
1472 kW
100% Efficiency = 1472 kW/12.4621 kWh/kg → 118.12 kg/h
True Input = 0.2003 kg/kWh × 1472 kW → 299.26 kg/h
Overall Engine Efficiency
118.12 kg/h/299.26% kg/h → 39.5%

### Exhaust Analysis:

The next step is to analyze the combustive efficiency of the engine. The same methodology has been employed as the previous document, only utilizing the information pertinent to the ABC engine. All computations are conducted using 1472 kW.

Fuel In
203.3 g/kWh
0.2033 kg/kWh
Using the C₁₂H₂₆ model for Diesel Fuel
0.4156 mol C/kWh × 1472 kW
→ 611.71 mol/h Carbon atoms
Non-CO₂ Carbon in Exhaust
CO - 0.51 g/kWh (0.51 g/kWh × 1472 kW)/(28 g/mol)
→ 26.81 mol/h Carbon atoms
HC - 0.91 g/kWh (0.91 g/kWh × 1472 kW)/(14 g/mol)
→ 95.68 mol/h Carbon atoms
PT - 0.08 g/kWh (0.08 g/kWh × 1472 kW)/(14 g/mol)
→ 8.41 mol/h
Total Non-CO₂ Carbon in Exhaust 8.41 mol/h + 95.68 mol/h + 26.81
mol/h → 130.90 mol/h
Combustion Reaction Efficiency
Carbon atoms administered to the system in the form of diesel fuel is fully
converted to CO₂ (611.71 mol C/h − 130.90 mol C/h)/611.71 mol
C/h → 79%
Carbon atoms administered to the system in the form of diesel fuel
exhausted in a form other than that of CO₂, thus taking potential
energy with it: 100% − 74% → 21%

### Energetic Model And Computation:

The non-CO₂ carbon constituents of diesel engine exhaust are a mixture of literally hundreds of different molecular structures ranging from the polymerase soot molecules and unchanged diesel fuel molecules down to the simplest hydrocarbon, methane. For the sake of this exercise, the mean energetic value between the diesel fuel model and methane has been used as a solid estimate of the energetic value for the hydrocarbon and particulate constituents of the exhaust.

HC And PT Computation:

HC- 95.68 mol/h Carbon atoms 95.68 mol/h/611.71 mol C/h
→ 15.64% ratio of carbon atoms from fuel
PT - 8.41 mol/h Carbon atoms 8.41 mol/h/611.71 mol C/h
→ 1.38% ratio of carbon atoms from fuel
Totals = 95.68 mol/h + 8.41 mol/h
→ 104.09 mol/h Carbon atoms
15.64% + 1.38% → 17.02% ratio of carbon atoms from fuel
Computation
17.02% × (299.26 kg/h × 12.462 kWh/kg)
→ 634.74 kW if diesel molecules
(802.34 kJ/mol × 104.09 mol/h) × (0.2778/1000 kWh/MJ)
→ 23.20 kW if methane
(634.74 + 23.20)/2 → 328.97 kW mean value

There is also a measured value for the CO component in the exhaust. Since the energy of formation is higher for CO than it is for CO₂, it is possible to calculate the energetic loss for this portion of the exhaust.

CO Component
Energetic Divergence

283 kJ/mol
26.81 mol/h
283 kJ/mol × 26.81 mol/h → 7587.63 kJ/h
(7587.63 kJ/h × 0.2778)/1000 → 2.11 kW

Overall energetic comparisons will take into account the sum total of these energetic computations to derive useful energetic data.

Potential Energy Total for Exhaust
2.11 kW + 328.97 kW → 331.08 kW
Comparisons
(4.22 kW + 331.08 kW)/((299.26 kg/h × 12.462 kWh/kg) − 1472 kW)
→ 15% fraction of total energetic losses
(4.22 kW + 331.08 kW)/1472 kW
→ 22% fraction of total output energy
(4.22 kW + 331.08 kW)/(299.26 kg/h × 12.462 kWh/kg)
→ 9% fraction of total input potential energy

### CONCLUSIONS

Although these calculations are not rigorous in the strictest sense, the assumptions are reasonable. The information provided by the computations shows beyond a reasonable doubt that there is a considerable value of potential chemical energy in the exhaust. The Combustion Management System is designed to capture this energy by increasing the rate of the combustion reaction to produce a more complete burn. No laws of physics are being refuted within the construct of this analysis; it is simply a more efficient chemical process.

### SUMMARY

The Combustion Management System models each hydrocarbon combustion application and supplies a product gas PG, comprising a dynamic mixture of nascent hydrogen (H) and oxygen (O), to the internal combustion engine to propagate the formation of hydroxide radicals (OH) and thereby to improve the level of completion of the hydrocarbon combustion reaction.

What is claimed as new and desired to be protected by Letters Patent of the United States is:

1. A system for regulating the operation of an engine, which receives hydrocarbon fuel from a source of hydrocarbon fuel and combustion air from a source of combustion air, wherein a mixture of the hydrocarbon fuel and combustion air is combusted in said engine to release at least one of mechanical energy and thermal energy as well as combustion by-products, said system for regulating the operation of an engine comprises:
product gas generator for producing a product gas comprising a substantially stoichiometric mix of hydrogen and oxygen; and
product gas injector for dynamically adding the product gas to the combustion air in a substantially predetermined ratio with hydrocarbon fuel, from the source of hydrocarbon fuel, presently consumed by the engine.

2. The system for regulating the operation of an engine of claim 1 wherein the product gas generator comprises:
converter for generating a stoichiometric mix of hydrogen and oxygen from water.

3. The system for regulating the operation of an engine of claim 2 wherein the product gas generator further comprises:
a catalyst mixed into the water to facilitate the electrolysis of the water.

4. The system for regulating the operation of an engine of claim 3 wherein the catalyst comprises:
at least one ionic salt that stays dissolved in solution in water.

5. The system for regulating the operation of an engine of claim 1 wherein the product gas generator comprises:
electrolysis system for using an electric current to dissociate a stoichiometric mix of hydrogen atoms and oxygen atoms from water.

6. The system for regulating the operation of an engine of claim 5 wherein the product gas generator further comprises:
a catalyst mixed into the water to facilitate the electrolysis of the water.

7. The system for regulating the operation of an engine of claim 6 wherein the catalyst comprises:
at least one ionic salt that stays dissolved in solution in water.

8. The system for regulating the operation of an engine of claim 1 wherein the product gas injector comprises:
hydrocarbon fuel consumption monitor for determining at least one engine operating characteristic from the set of engine operating characteristics including, but not limited to: hydrocarbon fuel flow from said source of hydrocarbon fuel, diesel engine throttle setting, diesel engine Revolutions Per Minute, diesel engine turbocharger Revolutions Per Minute, internal diagnostic array of the diesel engine, exhaust flow of the combustion by-products, diesel engine cylinder pressure, and the like, to dynamically determine a volume of hydrocarbon fuel presently consumed by the engine.

9. The system for regulating the operation of an engine of claim 8 wherein the product gas injector further comprises:
combustion characterization system for storing a set of data indicative of hydrocarbon fuel consumed corresponding to measured values of each selected monitored engine operating characteristic.

10. The system for regulating the operation of an engine of claim 9 wherein the product gas injector further comprises:
product gas volume computer for determining the volume of product gas corresponding to the substantially predetermined ratio of hydrocarbon fuel, from the source of hydrocarbon fuel, presently consumed by the engine, as indicated by the set of data corresponding to measured values of a selected monitored engine operating characteristic.

11. A method for regulating the operation of an engine, which receives hydrocarbon fuel from a source of hydrocarbon fuel and combustion air from a source of combustion air, wherein a mixture of the hydrocarbon fuel and combustion air is combusted in said engine to release at least one of mechanical energy and thermal energy as well as combustion by-products, said method for regulating the operation of an engine comprises:
producing a product gas comprising a substantially stoichiometric mix of hydrogen and oxygen; and
dynamically adding the product gas to the combustion air in a substantially predetermined ratio with hydrocarbon fuel, from the source of hydrocarbon fuel, presently consumed by the engine.

12. The method for regulating the operation of an engine of claim 11 wherein the step of producing comprises:
generating a stoichiometric mix of hydrogen and oxygen from water.

13. The method for regulating the operation of an engine of claim 12 wherein the step of producing further comprises:
adding a catalyst mixed into the water to facilitate the electrolysis of the water.

14. The method for regulating the operation of an engine of claim 13 wherein the catalyst comprises:
at least one ionic salt that stays dissolved in solution in water.

15. The method for regulating the operation of an engine of claim 11 wherein the step of producing comprises:
using an electric current to dissociate a stoichiometric mix of hydrogen atoms and oxygen atoms from water.

16. The method for regulating the operation of an engine of claim 15 wherein the step of producing further comprises:
adding a catalyst mixed into the water to facilitate the electrolysis of the water.

17. The method for regulating the operation of an engine of claim 16 wherein the catalyst comprises:
at least one ionic salt that stays dissolved in solution in water.

18. The method for regulating the operation of an engine of claim 11 wherein the step of dynamically adding comprises:
determining at least one engine operating characteristic from the set of engine operating characteristics including, but not limited to: hydrocarbon fuel flow from said source of hydrocarbon fuel, diesel engine throttle setting, diesel engine Revolutions Per Minute, diesel engine turbocharger Revolutions Per Minute, internal diagnostic array of the diesel engine, exhaust flow of the combustion by-products, diesel engine cylinder pressure, and the like, to dynamically determine a volume of hydrocarbon fuel presently consumed by the engine.

19. The method for regulating the operation of an engine of claim 18 wherein the step of dynamically adding further comprises:
storing a set of data indicative of hydrocarbon fuel consumed corresponding to measured values of each selected monitored engine operating characteristic.

20. The method for regulating the operation of an engine of claim 19 wherein the step of dynamically adding further comprises:
determining the volume of product gas corresponding to the substantially predetermined ratio of hydrocarbon fuel, from the source of hydrocarbon fuel, presently consumed by the engine, as indicated by the set of data corresponding to measured values of a selected monitored engine operating characteristic.
